(19) United States
(12) Patent Application Publication
(10) Pub. No.: US 2007/0106831 A1
(43) Pub. Date: May 10, 2007

(54) Computer system and bridge module thereof

(76) Inventors: Shan-Kai Yang, Taipei City (TW); Lei Ding, Shanghai (CN)

Correspondence Address: RABIN & Berdo, PC, 1101 14TH STREET, NW, SUITE 500, WASHINGTON, DC, 20005, US

(21) Appl. No.: 11/378,389

(22) Filed: Mar. 20, 2006

(30) Foreign Application Priority Data
Nov. 9, 2005 (TW) 094139220

(51) Int. Cl. G06F 13/36

(52) U.S. Cl. 710/306

(57) ABSTRACT

A computer system includes a bridge module plugged in a processor socket of a motherboard with multiple processors. The bridge module electrically connects two buses which have the same transmission protocol and connect to the socket. Thus, two processors or a processor and a chip set would communicate each other by the bridge module and the two buses without installing any processors or additional buses.

### BACKGROUND

1. Field of Invention

The invention relates to a computer system used in electronic data processing, and in particular to a computer system having a bridge module plugged into the socket of its processor, thus connecting it in series with one or more bus.

2. Related Art

In a computer system, the most essential constituting portion is the motherboard, which is used to carry and support the various electronic elements, among them the processor is the most important component, such as the central processing unit (CPU), that is responsible for the major task of various data operations, and thus is considered as the core of the entire computer system. In order to handle the increasingly complicated and sophisticated data processing, he capability of a single processor sometimes is not sufficient to cope with the requirement of operation, thus bringing about the emergence of the multi-processor system having two or more processors disposed on the same motherboard.

In the following description, the dual processor system is taken as an example to explain the principle of its operation, provided with two sockets on its motherboard for the two processors to be plugged in. Wherein, the operation of parallel multiplexed processing is utilized to raise the efficiency of data processing. In the above-mentioned structure, one configuration is that, the connection between two processors are achieved through a Bus, thus in every processor there is a corresponding chipset, and the connection between two chipsets is achieved through a Bus to perform the specific functions.

However, for such a framework, when the motherboard used for double processors is only plugged on with one processor, then in addition to the problem of increased load, the related functions of a chipset connected to vacant processor socket, such as the various functions of PCI expansion card connected to the PCI bridge chip may not be utilized at all, thus resulting in tremendous waste and inconvenience. This conditions often happen in the situations that one of the two processors is removed for low level operation application, or one of the two processors is removed for reparation.

Usually, when the functions of the idle chipset for the removed processor are desired to be used, then the idle chipset must first be connected to the remaining processor. For a similar arrangement, please refer to the dual processor system disclosed in U.S. Pat. No. 6,618,783, wherein, when one Input/Output (I/O) processor is out of operation, then other preset cross-coupled I/O processor is used to take over the control of the operation of the originally connected PCI I/O Card.

However, the arrangement of such a preset cross-coupled framework will inevitably add to the complexity of the circuit layout. In addition, when the socket of a processor is idle, the bus connected to it must be further processed to ensure proper operation of the system. For example, if bus termination processing has not been performed, then the continuously transmitted signals will be reflected back to the original transmitting device at the end of the bus since they have not been received by the idle processor, thus creating signal interference. This phenomenon tends to become even more serious in high speed bus. Consequently, the preset cross-coupled framework must be coupled with bus termination processing to ensure proper operation of the system, as such, it is not a very satisfactory solution.

Moreover, in the multi-processor system such as an 8 processors system, the devoid of any of the processors would cause the termination of connections with other processors or the increase of transmission delay. Thus, the afore-mentioned preset cross-coupled technology can not solve this problem due to the restriction of predetermined number of transmission channels of the respective processors.

### SUMMARY OF THE INVENTION

In view of the problems and shortcomings of the prior art, the invention provides a computer system and its bridge module, which can be used to maintain the communication between processor and chipset, processor and I/O controller or processor and sub-system, without having to install additional processors or change the framework of the original system.

According to one aspect of the invention, the motherboard of the computer system includes: a plurality of sockets of the first processor, at least one socket of the second processor, a plurality of the first buses and second buses, a plurality of processors and bridge modules. The respective sockets of the first processor are provided for other processor to plug in, and are electrically connected to the respective first buses. The bridge module is plugged into the socket of the second processor, and is electrically connected to both the first and second bus. In this arrangement, at least one processor is connected to a second bus through a first bus and a bridge module by making use of the characteristic of not discriminating the master/slave roles of the first bus and the second bus.

According to another aspect of the invention, the motherboard of the computer system includes: a plurality of sockets of the first processor, at least one socket of the second processor, at least a chipset, a plurality of the first buses and second buses, a plurality of processors and bridge modules. The respective sockets of the first processor are provided for other processors to plug in, and are electrically connected to the respective first buses. The bridge module is plugged into the socket of the second processor,.and is electrically connected to both the first and second bus. In this arrangement, at least one processor is in communication with the chipset through a first bus, a bridge module, and a second bus by making use of the characteristic of not discriminating the master/slave roles of the first bus and the second bus.

In the above-mentioned structure, the bridge module disclosed by the invention includes: a plurality of first electrical contacts and second electrical contacts plugged respectively to the sockets of the first processor, thus connecting electrically respectively to the first bus and second bus. The first electrical contacts and the second electrical contacts correspond to each other and having specific definitions, and form the respective communication links through circuit connection, so that at least one processor is in communication with one of: other processors, the chipset, the I/O controller and the sub-system through a first bus, a bridge module, and a second bus.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow illustration only, and thus are not limitative of the invention, and wherein:

FIG. 1 is a system block diagram of a dual processor computer system according to an embodiment of the invention;

FIG. 2A is an exploded view of a bridge module connected to a second processor socket according to an embodiment of the invention;

FIG. 2B is another exploded view of a bridge module connected to a second processor socket according to another embodiment of the invention;

FIG. 3 is a schematic diagram of another bridge module according to still another embodiment of the invention;

FIG. 4 is a system block diagram of applying a bridge module in the four-processor computer system according to yet another embodiment of the invention;

FIG. 5 is a system block diagram of applying a bridge module in the four-processor computer system according to still another embodiment of the invention; and

FIG. 6 is a system block diagram of applying a bridge module in the eight-processor computer system according to still another embodiment of the invention.

### DETAILED DESCRIPTION OF THE INVENTION

The purpose, construction, features, and functions of the invention can be appreciated and understood more thoroughly through the following detailed description with reference to the attached drawings.

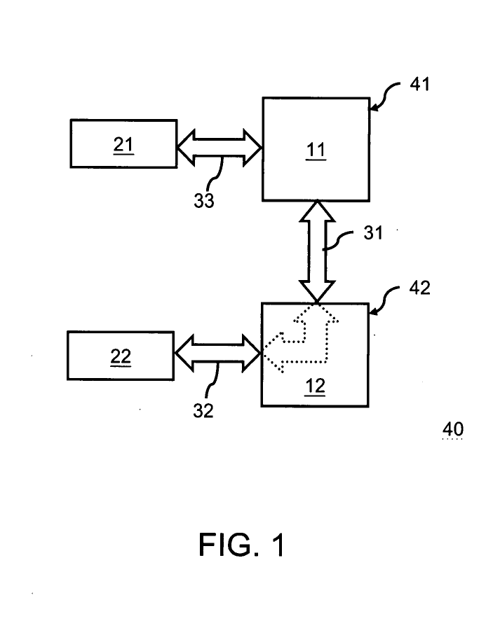

Firstly, refer to FIG. 1 for a system block diagram of a dual processor computer system according to an embodiment of the invention. As shown in FIG. 1, the double-processor system includes: a motherboard 40, a first bus 31, a second bus 32, a third bus 33, a processor 11, and a bridge module 12. A processor socket 41, a second processor socket 42, a first chipset 21, and a second chipset 22 are provided on a motherboard 40. Processor 11 is plugged onto the processor socket 41. A bridge module 12 is used to replace another processor 11 and plugged onto the second processor socket 42, and connected electrically indirectly to the first bus 31 and second bus 32, so as to make the first bus 31 in communication with the second bus 32. In the above-mentioned structure, the processor 11 may be: a central processing unit (CPU); the first chipset 21 and the second chipset 22 may be: a North Bridge, a South Bridge, a bridge chip incorporating a North Bridge and a South Bridge, or an I/O bridge chip.

The implementation of the first bus 31, the second bus 32, and the third bus 33 must in compliance with the specific data transmission protocol, for example, the Hyper Transport Protocol. Thus, this kind of bus can be utilized in the data transmission of a processor, a chipset, an Input/Output controller or a subsystem (in general, a second motherboard, which is provided with a plurality of expansion buses or other expansion functions), and it is essentially a uni-direction point-to-point bus. As such, the first bus 31 is disposed between the first processor socket 41 and the second processor socket 42, so that the processor 11 is electrically connected to the bridge module 12. While the second bus 32 is disposed between the second processor socket 42 and the chipset 22, and is used to connect the bridge module 12 and the chipset 22. And the third bus 33 is disposed between the first processor socket 41 and the chipset 21, so that the processor 11 is used to form communication with the chipset 12. Therefore, in addition to forming communication with the first chipset 21 through the third bus 33, so that the functions of processor 11 may be fully utilized, the processor 11 can also be used to form communication link with the second chipset 22 through the first bus 31, bridge module 12, and the second bus 32, thus allowing the functions chipset 22 to be fully utilized without having to install the second processor.

As to the technical requirement imposed on the first bus 31 and second bus 32 that are both connected to the second processor socket 42, in addition to the requirement that both of the two buses must transmit data in compliance with the specific data transmission specification, the first bus 31 and the bus 32 are of equal status relative to the Basic Input/Output System (BIOS), and there is no discrimination of master/slave role in the implementation of data transmission. In this case, the Opteron™ MP processor of AMD company is taken as an example, which is used to support three groups of transmission bus, and their statuses relative to BIOS is equal, and there is no restriction specifying that which bus is connected to which processor or which chipset. As such, under the condition that the processor 11 is plugged into the second processor socket 42, the first bus 31 may serve as a connection between the two processors 11; meanwhile, in case that a bridge module 12 is plugged into the second processor socket 42, the first bus 31 is connected to the second bus 32 to serve as a connection between the processor 11 plugged into the first processor socket 41 and the chipset 22.

Furthermore, the bridge module 12 can be a circuit board module, which is provided with the same package as the processor 11, so as to able to be plugged into the second processor socket 42. Of course, in the framework of not changing the structure of the motherboard 40, the first processor socket 41 can be of the same specification as that of the second processor socket 42. If the specification of the second processor socket 42 is changed due to special design, then the bridge module 12 may not have to be the same specification as does the processor 11, it may operate well by just being plugged into the second processor socket 42 and connected to it with certain specifically defined pins. The details of which will be described as follows.

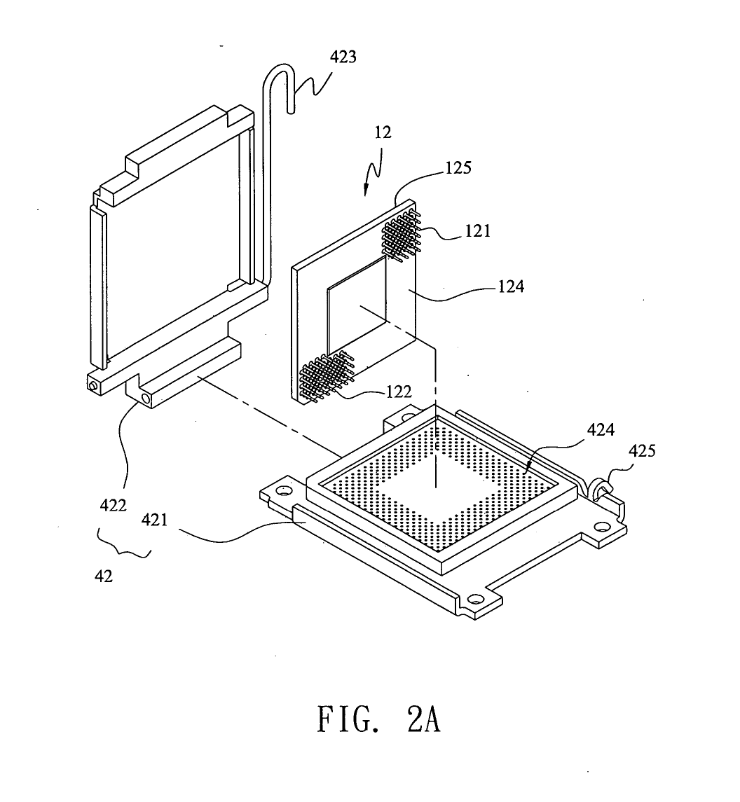

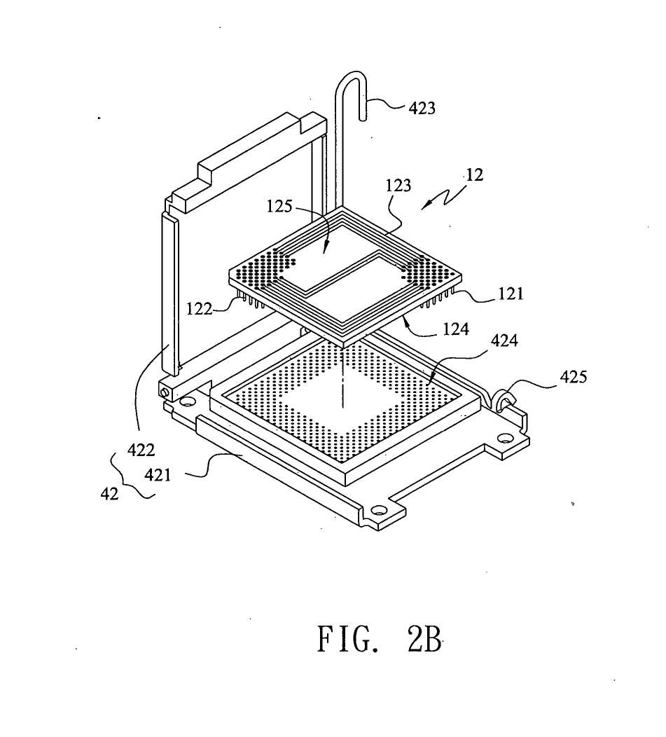

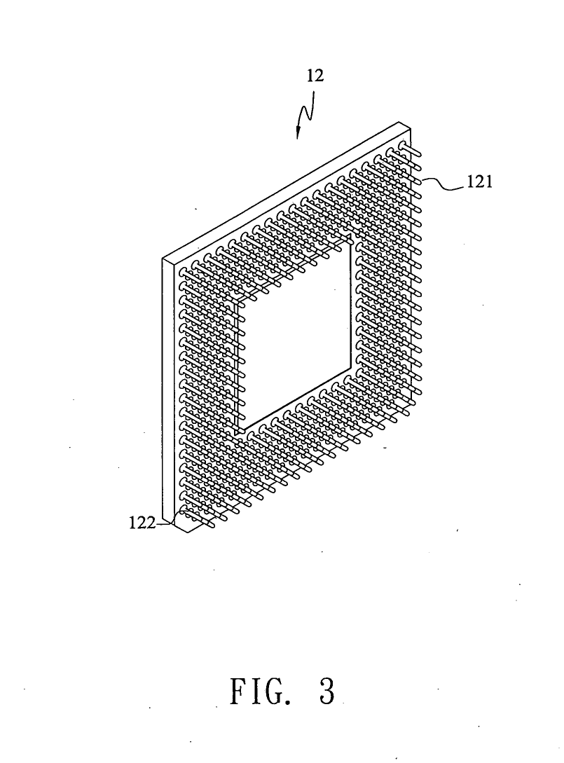

Next, refer to FIGS. 2A to 2B for the structure of connecting the bridge module to the processor socket of the computer system of the invention. FIG. 2A is an exploded view of a bridge module connected to a processor socket according to an embodiment of the invention. FIG. 2B is another exploded view of a bridge module connected to a processor socket according to another embodiment of the invention. As shown in FIG. 2A, the bridge module 12 is a circuit board module having a processor packaging structure and is disposed on a bottom seat 421 of a second processor socket 42, and is fixed and secured by a card arm 423 of upper hood 422 and a card hook 425 of the bottom seat 421. A first side 124 of the bridge module 12 is provided with a plurality of protruding first electric contacts 121 and second electric contacts 122, used for inserting into a plurality of corresponding inserting holes 424 on the bottom seat 421. In the respect insertion holes 424 are imbedded with electric contact (not shown), used for electrically connecting the first electric contacts 121 and the second electric contacts 122 to the traces (not shown) of the first bus 31 and the second bus 32 (FIG. 1) on the motherboard 40. The respective corresponding first electric contacts 121 and second electric contacts 122 are connected by making use of circuit 123 of the second side 125, so that the first bus 31 and second bus 32 are connected to each other as shown in FIG. 1. The positions of the first and second electric contacts 121,122 relative to that of the connected circuit 123 are not subject to any restrictions. Thus, circuit 123 may be provided on the same side or different side of the first and second electric contacts 121,122. If the multi-layer circuit board is utilized, then circuit 123 may not appear on the surface of bridge module 12. In addition, if the second processor socket 42 remains intact, then the first electric contacts 121 and the second electric contacts 122 can be the metallic pins, and their pitches, lengths, and diameters are the same as those of the processor 11. Naturally, the entire surface of the first side may be designed and provided with pins (FIG. 3), their number is the same as that of processor 11, however, its application is only restricted to circuit connection.

Moreover, the second processor socket 42 as shown in FIGS. 2A & 2B are for illustration purpose only, however it is not intended to restrict the scope and configuration of the bridge module 12. Nevertheless, its configuration corresponds to that of bridge module 12 having Pin Grid Array (PGA) package. In case that the bridge module is used to replace a processor having pins configuration of Land Grid Array (LGA) package, then the bridge module must be provided with a plurality of metal pads having LGA package as the electric contacts. Correspondingly, the bottom seat of the second processor socket must be provided with a plurality of protruding electric contacts for connecting to the metal pads.

Furthermore, as to the definitions of the first electric contacts 121 and the second electric contacts 122, the buses in compliance with the Hyper-Transport protocol such as the first bus 31 and second bus 32 are taken as examples, they must likewise be in compliance with the Hyper-Transport protocol. Similarly, for the electric contact on the second processor socket 42 it is the same case. Herein, the processor pin descriptions of chapter 6, AMD Functional Data Sheet, 940 Pin Package, 31412 Rev 3.05 June 2004, is taken as an example. There have pins definitions with three HT LINKS which are the respective pin positions of three buses supported by a processor. In case that a processor is plugged onto a processor socket, then the three buses are all operational. However, in case that a bridge module is plugged onto a processor socket, then two buses may be chosen to be operational, thus only pins HT LINK0, HT LINK1 have to be connected to the electric circuit, so the pins defined by HT LINK0, HT LINK1 are first and second electric contacts 121 and 122 respectively. However, it worthy to note that, the number of bus the bridge module is capable of connecting is restricted by the predetermined number of transmission channels of a processor. Thus, in case the processor is capable of supporting four or five transmission channels, then the bridge module may be used to connect to two pair of buses among them.

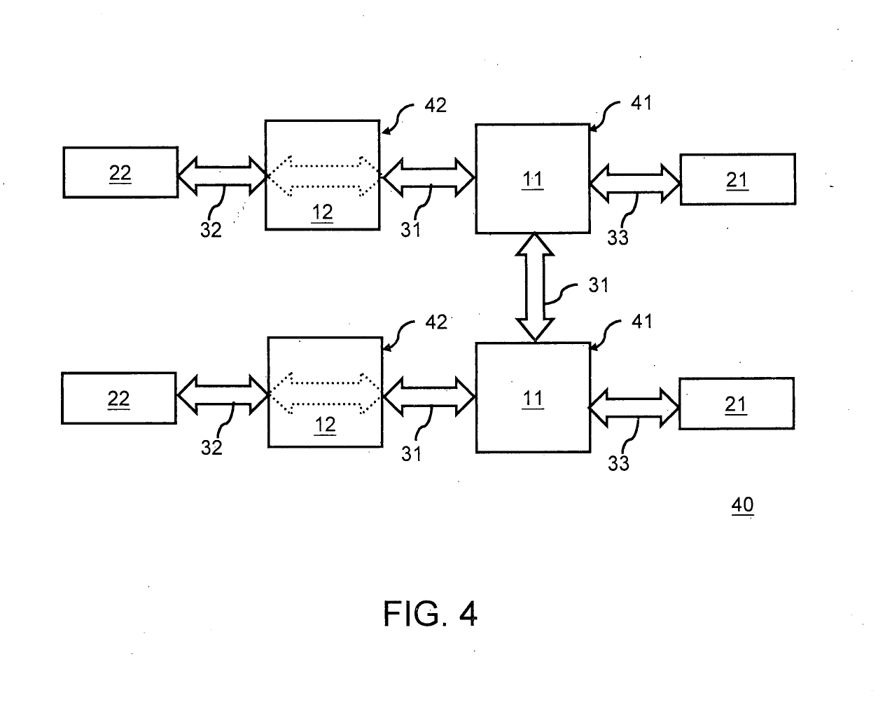

Then, refer to FIG. 4 for a system block diagram of applying a bridge module in the four-processor computer system according to yet another embodiment of the invention. As shown in FIG. 4, in which the two processors are replaced by two bridge modules respectively, a processor 11 is plugged onto the first processor socket 41, thus the three buses (2 the first buses 31 and 1 the third bus 33) connected to it are all operational, and connected respectively to another processor 11, a bridge module 12 plugged onto the second processor socket 42 and a first chipset 21. On the other hand, since the bridge module 12 is plugged onto the second processor socket 42, as such, only the first bus 31 and the second bus 32 are operational, and connected respectively to a processor 11 of the first processor socket 41 and a second chipset 22.

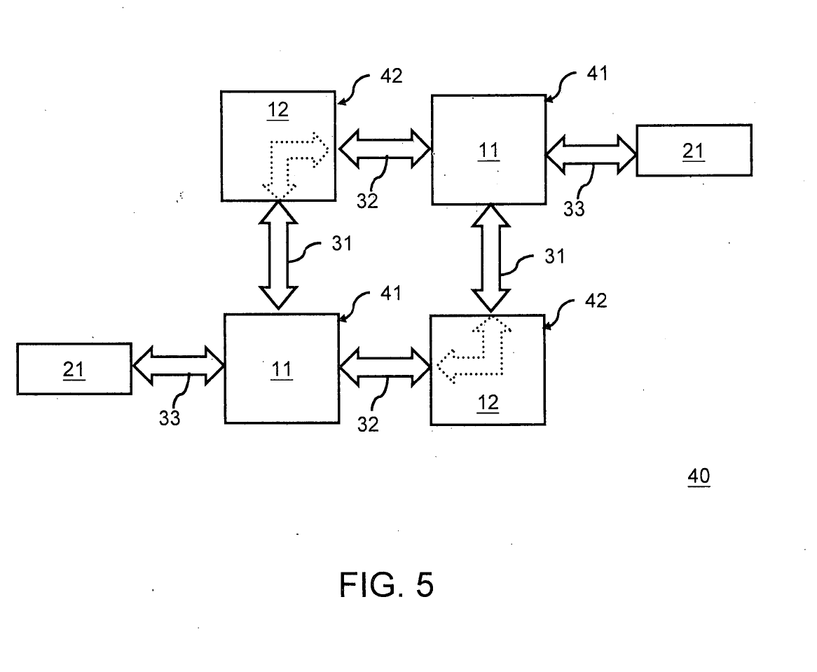

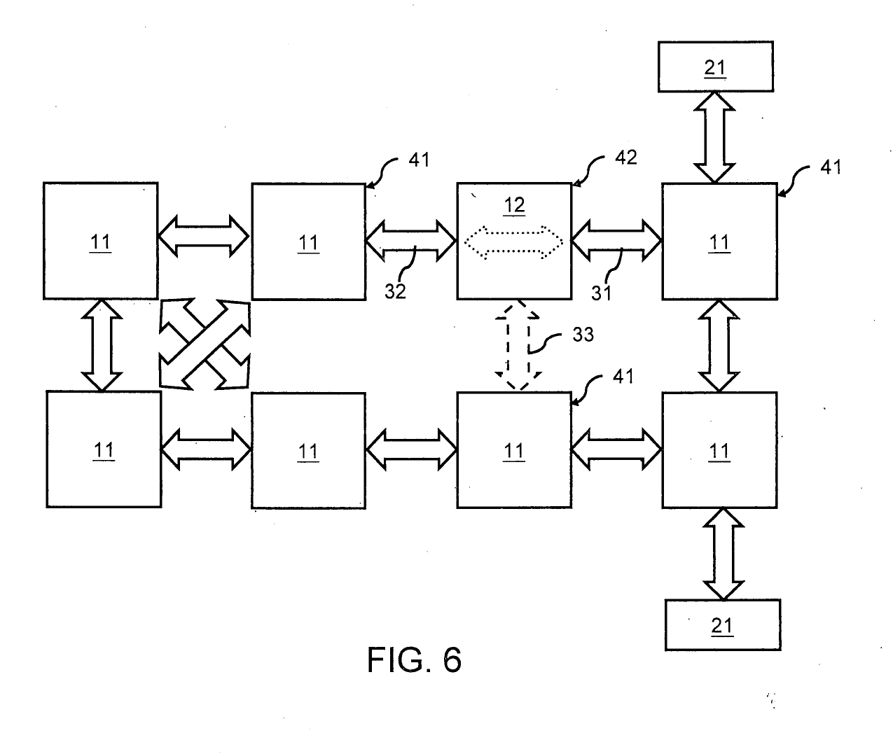

In addition to being connected to chipset, the bridge module can also be used to connect between the processors. In this connection, refer to FIG. 5 for a system block diagram of applying a bridge module in the four-processor computer system according to still another embodiment of the invention. The two bridge modules 12 plugged onto the two second processor sockets 42, are connected to two pairs of a first buses 31 and a second buses 32 respectively, so that the two processors 11 plugged onto two first processor sockets 41 may communicate with each other. In case that the transmission latency between processors is defined as the least number of buses that must be traversed for communications between any two processors, then in this case of replacing the processors 11 with bridge modules 12 does not create any transmission latency, namely, when Latency=2, the transmission latency is not increased. Subsequently, refer to FIG. 6 for a system block diagram of applying a bridge module in the eight-processor computer system according to still another embodiment of the invention. In this case, each of the processors 11 may be used to support three buses. The second processor socket 42 is connected separately to three processors 11 via a first bus 31, a second bus 32, and a third bus 33. The bridge module 12 is connected to a first bus 31 and a second bus 32, so that the transmission latency of the two farthest processors 11 are kept at 3. For the idle third bus 33, the bus interruption technology of the prior art can be utilized on the bridge module 12, as such avoiding the signal interference problem.

Likewise, the computer systems having more than eight processors may be handled in a similar manner. These multi-processor systems are practical embodiments of the present invention, and will not repeat here for brevity.

It must be emphasized here that, the one or more pairs of buses connected to the bridge module are not restricted to those in compliance with the Hyper Transport Protocol. The bridge module may be applied to any types of buses having mutually equal status and without discrimination of the master/slave roles that are in compliance with the same data transmission protocol.

Moreover, in addition to being disposed between two processors or between a processor and a chipset for data communication as disclosed in the afore-mentioned embodiments, the bridge module may also applied to the bridging between processor and input/output controller, or between the processor and sub-system.

In addition, in practical applications, the question as to how the computer system is used to determine the device plugged onto a certain processor socket is a processor or a bridge module, that can be solved by changing the status of the General Purpose Input/Output (GPIO) Pins of the processor insertion slot, and then supplying this information to the BIOS to determine and execute the related programs. However, this is not the major issue of the invention, and it will not be discussed here for brevity and simplicity.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer system, including a motherboard, said motherboard further comprising:
at least one first processor socket and at least one second processor socket;
at least one first bus, electrically connected to said first processor socket and said second processor socket;
at least one second bus, electrically connected to said second processor socket;
at least one processor, plugged onto said first processor socket, and electrically connected to said first bus through said first processor socket; and
at least one bridge module, plugged onto said second processor socket, and electrically connected to both said first bus and said second bus through said second processor socket;
wherein said processor is electrically connected to said second bus through said first bus and said bridge module.

2. The computer system of claim 1, wherein said bridge module is a circuit board module having the same package as-that of said processor.

3. The computer system of claim 1, wherein said first bus and said second bus are operated in compliance with the same transmission protocol, and transmit data without difference of master/slave.

4. The computer system of claim 1, wherein said first bus and said second bus are in compliance with the Hyper Transport specification.

5. The computer system of claim 1, wherein said first processor socket and said second processor socket are of the same specification.

6. The computer system of claim 1, wherein said bridge module is provided with Pin Grid Array (PGA) package or Land Grid Array (LGA) package.

7. The computer system of claim 1, wherein said bridge module having a plurality of first electric contacts and a plurality of second electric contacts with the same specification as that of said processor, and the first electric contacts and the second electric contacts are electrically connected respectively to said first bus and said second bus.

8. The computer system of claim 7, wherein said first electric contacts and said second electric contacts are corresponding to each other with specific definitions, and form respective communication links through circuit connection.

9. The computer system of claim 7, wherein said first electric contacts and said second electric contacts are in compliance with the Hyper Transport specification.

10. The computer system of claim 1, wherein said second bus is electrically connected to one of the group consisting of a chipset, another first processor socket, an input/output controller, and a sub-system.

11. A computer system, including a motherboard, said motherboard further comprising:
at least one first processor socket and at least one second processor socket;
at least one chipset;
at least one first bus, electrically connected to said first processor socket and said second processor socket;
at least one second bus, electrically connected to said second processor socket and said chipset;
at least one processor, plugged onto said first processor socket and electrically connected to said first bus through said first processor socket; and
at least one bridge module, plugged onto said second processor socket, and is electrically connected to both said first bus and said second bus through said second processor socket;
wherein said processor communicates with said chipset through said first bus, said bridge module, and said second bus.

12. The computer system of claim 11, wherein said bridge module is a circuit board module having the same package as that of said processor.

13. The computer system of claim 11, wherein said first bus and said second bus are operated in compliance with the same transmission protocol, and transmit data without difference of master/slave.

14. The computer system of claim 11, wherein said first bus and said second bus are in compliance with the Hyper Transport specification.

15. The computer system of claim 11, wherein said first processor socket and said second processor socket are of the same specification.

16. The computer system of claim 11, wherein said bridge module is provided with Pin Grid Array (PGA) package or Land Grid Array.(LGA) package.

17. The computer system of claim 11, wherein said bridge module has a plurality of first electric contacts and a plurality of second electric contacts with the same specification as that of said processor, and the first electric contacts and the second electric contacts are electrically connected respectively to said first bus and said second bus.

18. The computer system of claim 17, wherein said first electric contacts and said second electric contacts are corresponding to each other with specific definitions, and form the respective communication links through circuit connection.

19. The computer system of claim 17, wherein said first electric contacts and said second electric contacts are in compliance with the Hyper Transport specification.

20. A bridge module for replacing a second processor to be plugged onto a second processor socket on a motherboard, said second processor socket being electrically connected a first bus and a second bus, said bridge module comprising:
a plurality of first electric contacts, plugged onto said second processor socket and electrically connected to said first bus; and
a plurality of second electric contacts, plugged onto said processor socket and electrically connected to said second bus;
wherein said first electric contacts and said second electric contacts are corresponding to each other with specific definitions, and form respective transmission links through circuit connection.

21. The bridge module of claim 20, wherein said first electric contacts and said second electric contacts are in compliance with the Hyper Transport specification.

22. The bridge module of claim 20, wherein both said first electric contacts and said second electric contacts are of the Pin Grid Array (PGA) package or Land Grid Array (LGA) package.

23. The bridge module of claim 20, wherein said first bus and said second bus are operated in compliance with the same transmission protocol, and transmit data without difference of master/slave.

24. The bridge module of claim 20, wherein said first bus and said second bus are in compliance with the Hyper Transport specification.

25. The bridge module of claim 20, wherein said first bus is connected to a first processor socket.

26. The bridge module of claim 25, wherein said second bus is electrically connected to one of the group consisting of a chipset, another first processor socket, an input/output controller, and a sub-system.

27. The bridge module of claim 20, wherein said first electric contacts and said second electric contacts are all protruding metal pins of metal pads.
